(19) United States
(12) Patent Application Publication
(10) Pub. No.: US 2001/0034687 A1
(43) Pub. Date: Oct. 25, 2001

(54) Service contracts and commodities market for trading service contracts

(76) Inventors: Arthur Roland Bushonville, Winnetka, IL (US); Norbert Peter Schenk, Chicago, IL (US)

Correspondence Address: BANNER & WITCOFF, LTD., TEN SOUTH WACKER DRIVE, SUITE 3000, CHICAGO, IL, 60606, US

(21) Appl. No.: 09/728,101

(22) Filed: Dec. 1, 2000

Related U.S. Application Data
(60) Provisional application No. 60/168,522, filed on Dec. 2, 1999.

(51) Int. Cl. G06F 17/60

(52) U.S. Cl. 705/37; 705/26; 705/7; 705/27

(57) ABSTRACT

Market liquidity for service-based commodities is established by fixing contract maturity dates and directing spot market trades to these fixed dates. Service contracts have the following characteristics: a specific duration during which the service is to be provided, a specific service quality, a specific service delivery date, a specific service maturity date and a specific delivery location. The contract maturity dates are consistent with forward contract delivery dates, preferably, monthly or quarterly. Unlike a traditional goods-based futures contract, each forward contract, after delivery, does not stop trading but continues to trade on spot markets until maturity. Market information for each type of service contract is provided to users of an exchange system, preferably implemented within a publicly available network, such as the Internet or World Wide Web. Based on this market information, users may submit quote proposals (e.g., bid or offers) or quote acceptances.

### CROSS-REFERENCE TO RELATED APPLICATIONS

The present application claims priority under 35 U.S.C. §119(e)(1) from U.S. patent application Ser. No. 60/168,522 entitled “METHOD AND APPARATUS FOR A SERVICE CONTRACT COMMODITIES MARKET” filed on Dec. 2, 1999.

### TECHNICAL FIELD

The present invention is principally related to commodity trading systems and, in particular, to service-based commodity contracts and use thereof in a commodities market.

### BACKGROUND OF THE INVENTION

Exchange driven commerce systems are well-known in the art. These systems, such as the New York Stock Exchange (NYSE) or the Chicago Mercantile Exchange (CME), match buyers and sellers by offering an efficient, fair and orderly marketplace. For example, in a commodities exchange, buyers are free to submit bids on well-defined commodities and sellers likewise submit offers on the same commodities. The exchange effectuates communications that allow for the matching process between bids and offers to take place. Increasingly, such exchanges are making steps at automating their systems. Automated exchange-driven commerce systems for trading various instruments are disclosed in, for example, U.S. Pat. Nos. 4,903,201 and 5,924,083.

Generally, almost any fungible good can be treated as a commodity. For example live cattle, random-length lumber, various foreign currencies, interest rates and stock indices, to name a few, are currently traded as commodities. These types of commodities are traded according to predefined contracts. A typical commodity contract sets forth a specific quantity of a given type of goods, a specific quality for the goods, a specified delivery date and specified delivery location. By standardizing contracts in this manner, buyers and sellers are able to efficiently trade quickly and reliably. Such contracts are often referred to as forward or futures contracts because the delivery or maturity date is set to a date in the future. Prior to the maturity date of a given contract type, traders are able to buy and sell such contracts on the market. Once the maturity date for a given contract type arrives, trading is no longer possible. A different type of market for various contracts is the so-called spot market. In contrast to futures markets, the spot market for a commodity is the price for a specific quantity and quality of that good for immediate delivery at a specified location.

Concurrently, the use of publicly-available communication networks, such as the Internet, have brought about a dramatic rise in electronically-transacted commerce, often referred to as e-commerce. For example, on-line auction sites, such as that provided by eBay, Inc., have become well known. Such auctions are examples of seller-driven systems in which the seller defines contract terms but does not necessarily define a price for the goods to be sold. Another type of auction site is that provided by priceline.com, Inc. in which buyers are allowed to state the terms under which they are willing to complete a purchase. In a similar vein, on-line “exchange” systems, typically dealing in “non-traditional” commodities, have also been recently developed. For example, several websites on the Internet have recently been created that provide a forum for buyers and sellers of long distance telephone service. While these new buying and selling forums have expanded trading boundaries, they do not always function in the same manner as traditional markets.

One obvious difference between these newer markets and more traditional markets is that the commodities being traded are not necessarily goods. For example, the telephone bandwidth or long distance minutes referred to above are more accurately termed a service than a good. This results in differences in the way the service commodities are traded. For example, in contrast to spot markets for goods, the spot market for a service is the price of the service for a fixed amount of time commencing immediately at a specified location. For example, the spot market on a given day and time for long distance telephone service could be $36,000 for one year of T1 line use between Los Angeles and New York City for immediate connection. However, it is often the case that the various service “contracts” being offered are not equivalent to the extent that they do not conform to standardized terms. For example, one seller may offer a service having a different duration than an otherwise equivalent service offered by a different seller. Furthermore, the start date of each seller's service may not be the same. In general, random delivery dates (conceivably every business day of the year), and therefore contract maturity dates (i.e., the date delivery of the service terminates), will not foster liquid trading. This lack of standardized service contracts inhibits market efficiency and price discovery, thereby decreasing the likelihood of a successful market in the first instance.

Therefore, it would be advantageous to provide a framework through which standardized service commodity contracts can be traded in a manner similar to more traditional commodity exchanges.

### SUMMARY OF THE INVENTION

The present invention provides a technique for implementing trades and establishing markets in service commodity contracts and provides a commodity exchange system for trading such contracts. In particular, the present invention creates liquidity for service-based contracts by fixing the contract maturity dates and directing spot market trades to these fixed dates. Service contracts in accordance with the present invention are for a service for a fixed period of time rather than a specified amount of a good and have the following characteristics: a specific duration during which the service is to be provided, a specific service quality, a specific service delivery date, a specific service maturity date and a specific delivery location. The contract maturity dates are consistent with forward contract delivery dates, preferably, monthly or quarterly. Because services susceptible to trading as commodities are typically delivered over a period of time (rather than all at once as with traditional goods-based commodities), the forward market and the spot market operate together. That is, after delivery, each forward contract becomes a spot market maturity date and, unlike a traditional goods-based futures contract, does not stop trading but continues to trade until maturity. Spot delivery remains immediate, and the duration of the service corresponds to the maturity date specified in the original forward contract.

Based on such standardized service contracts, market information for each type of service contract is provided to users of an exchange system. Based on this market information, users may submit quote proposals (e.g., bid or offers) or quote acceptances. Preferably, an exchange system in accordance with the present invention is implemented within a publicly available network, such as the Internet or World Wide Web.

### BRIEF DESCRIPTION OF THE DRAWINGS

FIG. 1 is a timeline illustrating operation of service commodity contracts in accordance with the present invention.

FIG. 2 is a block diagram of a computer system in accordance with the present invention.

FIG. 3 is a block diagram of a preferred embodiment of an exchange controller in accordance with the present invention.

FIG. 4 is a block diagram illustrating an exchange process in accordance with the present invention.

FIG. 5 illustrates an exemplary market information display format for particular use in providing a market display in accordance with the present invention.

### DETAILED DESCRIPTION OF THE INVENTION

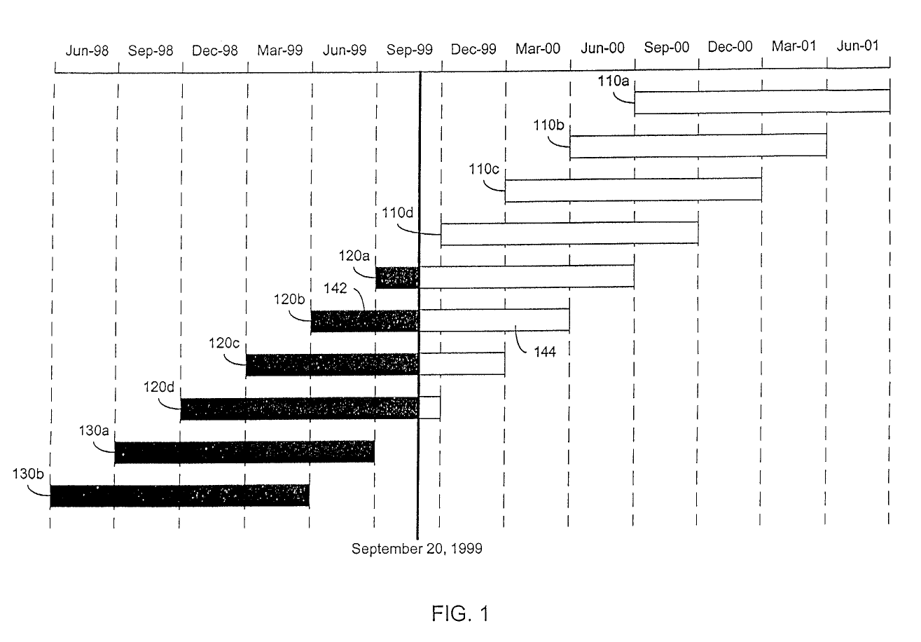

The present invention may be more fully described with reference to FIGS. 1-5. FIG. 1 illustrates operation of service commodity contracts 110, 120, 130 in accordance with the present invention. Note that the dates, ranges, durations etc. illustrated in FIG. 1 are for illustrative purposes only and are not intended to represent limitations on the present invention. In general, the terms service or services as used herein refer to any types of service that are fungible and capable of being delivered over a period of time. The present invention is applicable any type of service meeting these criteria and is not limited in this regard. For example, equivalent grades of long distance telephone services may be provided for a fixed period of time. Other examples include, but are not limited to, janitorial services, security services, etc.

The service contracts illustrated in FIG. 1 may be divided into three categories: forward market contracts 110, spot market contracts 120 and expired contracts 130. A specific duration during which the service is to be provided, a specific service quality, a specific service delivery date, a specific service maturity date and a specific delivery location define each of the forward contracts 110. Other information associated with each contract includes information sufficient to uniquely identify the seller of the service contract. The duration of each contract is fixed to an appropriate industry norm. For example, in the case of long distance telephone service, duration of one year may be considered appropriate. Other services will require other durations appropriate to the particular services types. Likewise, the quality and delivery location terms are also determined according to accepted industry norms. For example, long distance telephone services may be differentiated in quality according to E1 or T1 line types, with delivery locations corresponding to switching centers located within major metropolitan areas. The specified delivery date and, based on the duration, the specified maturity date of each contract are preferably constrained to a limited number of dates. In a preferred embodiment, delivery and maturity dates are restricted to monthly or quarterly boundaries. However, it is understood that other more or less frequent boundaries could be used as appropriate for a given service type. In the example illustrated in FIG. 1, quarterly boundaries based on a calendar year are shown, with durations constrained to one year. As a result, the contracts are fungible and continuity is provided between forward contracts and contracts currently trading on the spot market.

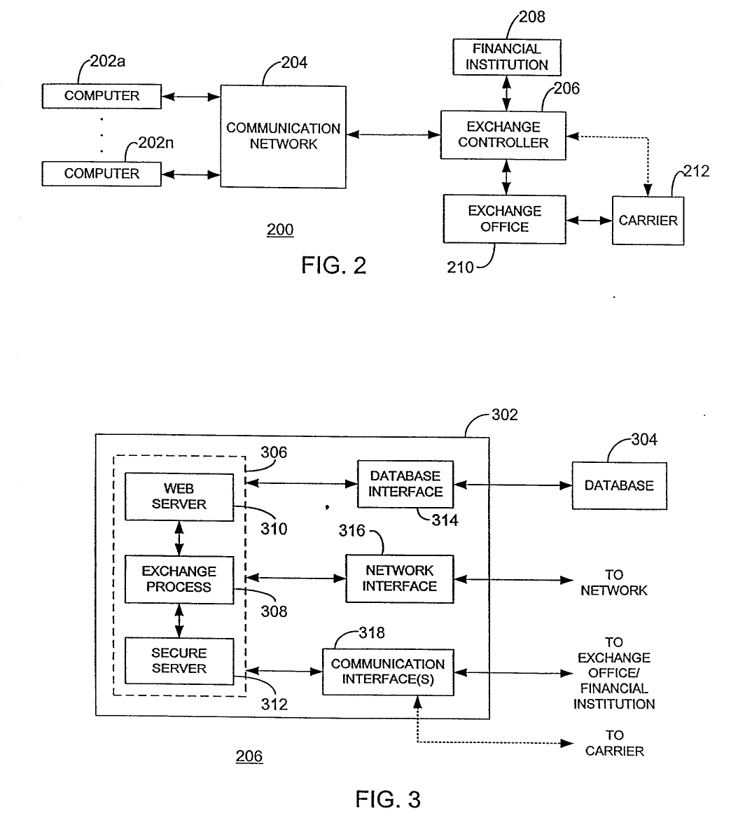

Unlike traditional goods-based commodity contracts, service contracts in accordance with the present invention may continue to be traded after delivery dates have occurred. In particular, contracts for which the delivery date has passed are moved from the forward market to the spot market as shown in FIG. 1. An expired portion 142 and a forward portion 144 characterize these spot contracts 120. Because the service is capable of being delivered over a period of time (i.e., the duration of the contract), the forward portion 144 of the contract may be traded on a spot market. Presumably, as the forward portion 144 of a given contract is reduced with the progression of time, market forces will reflect a change in price in the spot contract up to immediately prior to the maturity date of that contract. For example, if it is assumed that the current trading date is Sep. 20, 2000 (as illustrated by the heavy line), contracts 120 having various forward portions remaining will be available in the spot markets. This feature provides an added degree of flexibility previously unavailable to buyers and sellers of commodities. This feature also represents an additional revenue opportunity for exchange operators based on the traditional revenue models employed by commodity exchanges. Once the maturity date of a given service contract has passed, it becomes an expired contract 130 and is no longer traded on any market. Service contracts standardized in this manner are readily susceptible to trading via an automated exchange, as illustrated in FIGS. 2-4.

FIG. 2 illustrates a computer system 200 comprising a plurality of computers 202 in communication with each other through a communication network 204. An exchange controller 206, coupled to the communication network 204, is capable of communicating with the computers 202. In a preferred embodiment, the communication network 204 comprises a publicly available computer network, such as the Internet or World Wide Web. However, it is understood that the present invention is not limited in this regard; the network 204 may comprise or include a private computer network. Each of the computers 202 is preferably a personal computer, typically for use in the home or office. At a minimum, each computer 202 should support a common communication protocol with the exchange controller 206, preferably the so-called TCP/IP suite of protocols used to support Internet and “ETHERNET” communications. Of course, other communication protocols could be equally used dependent, in part, upon the type of communication network 204 employed.

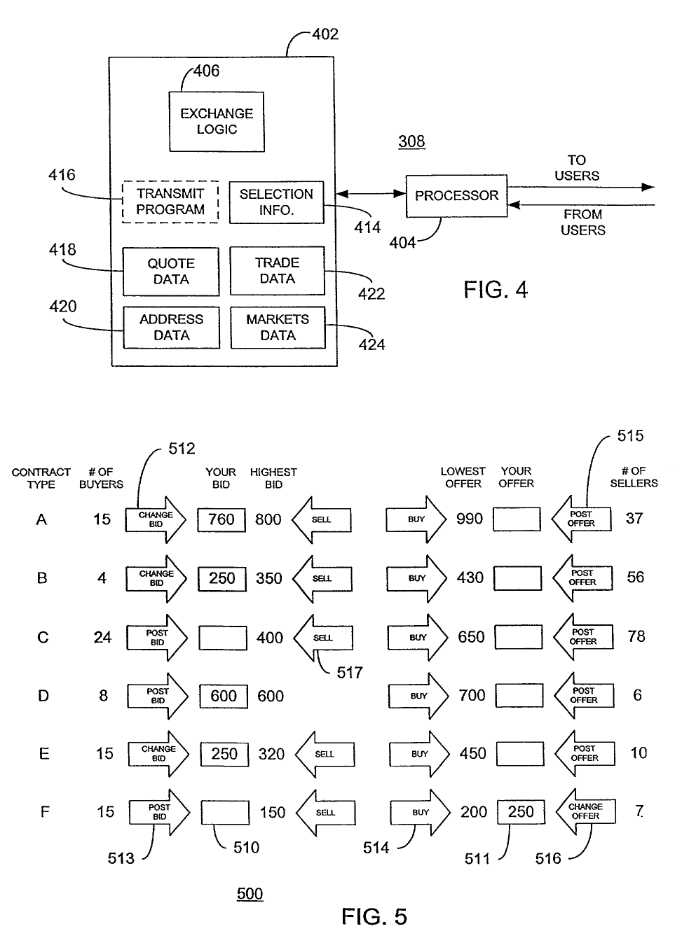

The exchange controller 206 serves to implement an on-line commodities exchange in accordance with the present invention and will be described in further detail with reference to FIGS. 3 and 4. Generally, the exchange controller 206 functions to automate interface operations with potential buyers and sellers of a given commodity, to implement exchange functionality (e.g., display market information, identify potential trades, etc.) and to support settlement activities. To this end, the exchange controller 206 is in communication with one or more financial institutions 208 capable of verifying customer credit availability and limits, issuing payments, holding funds while awaiting transaction clearance and the like. The exchange controller 206 is also in communication with an exchange office 210. The exchange office 210 includes personnel required to maintain operation of the exchange controller 210, field customer inquiries where necessary, ensure order settlement and to generally administer operations of the exchange. In one embodiment of the present invention, the exchange office 210 communicates with a carrier 212 in order to facilitate settlement of completed transactions. That is, the exchange office 210 receives information regarding completed transactions (transactions in which a buyer agreed to a seller's offering price or in which a seller agreed to a buyer's bid price) from the exchange controller 206 and forwards any information necessary for a carrier 212, if required, to perfect delivery of the desired commodity. It is anticipated that communications between the exchange controller 206 and the carrier 212 can also be performed directly (as illustrated by the dotted link) such that the necessary information is forwarded directly to the carrier 212 once a transaction has been completed.

Referring now to FIG. 3, a more detailed view of a preferred embodiment of the exchange controller is provided. The exchange controller comprises at least two servers 302, 304, such as “SUN” “ENTERPRISE” 350 servers, operating in combination to provide an on-line exchange system. It is understood that the present invention need not be limited to an on-line implementation, and is susceptible to other implementations. For example, communications between individuals and the exchange controller 206 could be carried out using telephone, facsimile, postal mail or other off-line methods of communication. It is further understood that other implementations (including various hardware implementations) encompassing the same functionality as described herein will be readily apparent to those having ordinary skill in the art. In the implementation shown, a first server 302 communicates via a database interface 314 with a second server configured to operate as a database 304. Techniques for configuring servers in this manner are well known in the art. The database 304 stores all relevant information necessary to complete commodities transactions, such as buyer and seller identifications, account identifications, passwords, information regarding specific quotes (bids and/or offers), credit information, etc.

The first server 302 implements the exchange functionality 306. As shown, the exchange functionality 306 encompasses an exchange process 308, a web server 310 and a secure server 312. Although not shown, the first server 302 comprises one or more processing units (such as microprocessors, microcontrollers, etc.) executing stored, computer-readable instructions to provide the exchange functionality 306. Likewise, the various interfaces 314-318 shown incorporate hardware and software implementations, as known in the art.

The exchange process 308 implements functionality, other than user-interface functionality, necessary to provide an automated commodity exchange system including, but not limited to, providing data to the web server 310 for presentation to a user of the exchange system. The exchange process 308 is described in further detail with regard to FIG. 4. The web server 310 handles all non-secure interactions between the exchange controller and the computers 202 residing on the computer network 204. In a preferred embodiment, data received from the exchange process 308 by the web server 310 comprises HTML-compliant data suitable for presentation via a web page. In contrast, the secure server 312 handles all secure interactions (such as would be used when providing financial account data or other confidential information to the exchange controller) between the controller 206 and computers 202.

The network interface 316 couples the controller 206 to the computer network 204. This includes support and termination of network protocols necessary to communicate via the computer network 204. In particular, the network interface 316 operates to recognize transmissions intended for the exchange controller and, in a similar manner, to ensure that communications being sent to various computers 202 are properly routed. Although shown as a separate component from the web server 310 and secure server 312, it is understood that the functionality provided by the network interface 316 could be incorporated into one or both of the servers 310, 312.

As shown, the communication interface(s) 318 allow the controller 206 to communicate with the exchange office 210, for example through the use of a dial-up line, a direct T1 connection or the like, or a secure Internet connection. The communication interface(s) 218 may also be used to communicate with one or more financial institutions using, for example, a direct T1 connection or the like, or a secure Internet connection. Additionally, the communication interface(s) 218 can be used to directly communicate with carriers used to settle the various transactions, although non-automated communications with such carriers are also possible and would provide, at least initially, a more easily implemented alternative.

Referring now to FIG. 4, a more detailed view of the exchange process 308 of FIG. 3 is presented. The exchange process 308 is preferably implemented using computer-readable instructions and data structures stored on a computer-readable medium 402 and executed by a processor 404 (e.g., a microprocessor, microcontroller and the like). Additionally, the computer-readable medium 402 may also store data that is manipulated by the processor 404 in conjunction with the execution of the computer-readable instructions. The processor 404 is preferably resident on the first server 302, whereas the computer-readable medium 402 may reside in the first server 302, the database 304 or a combination of the two. Although the computer-readable medium 402 preferably comprises random-access memory (RAM) and/or read-only memory (ROM) resident in the exchange controller 206, the computer-readable medium 402 may also comprise other non-resident storage media, such as magnetic cassettes, floppy disks, flash memory cards, digital video disks, Bernoulli cartridges, RAMs, ROMs, and the like.

As shown, the computer-readable medium 402 comprises exchange logic 406, a selection information storage structure 414, an optional transmit program 416, quote data 418, address data 420, trade data 422 and markets data 424. The exchange logic 406 implements those functions, preferably through the use of computer-readable instructions, susceptible to automation and necessary to conduct exchange operations. Such functions include, but are not limited to, processing user accounts, providing displays of markets, receiving bids and offers, recognizing matches between submitted bids and offers, processing acceptances of bids and/or offers and other exchange-oriented processing. Those having ordinary skill in the art will recognize other functionality useful in implementing an on-line exchange system may be similarly included in the exchange logic 406. The processor 404 executes the exchange logic 406.

The selection information storage structure 414 is adapted to receive selection information corresponding to the commodities being traded. Users of the exchange system, having viewed market information (described below relative to FIG. 5) may enter selection information regarding various ones of the commodities contracts against which they desire to enter a bid or offer. Thus, the particular format of the selection information storage structure 414 is dependent, in part, upon the commodities being traded. In the context of the present invention, the selection information storage structure 414 comprises the particular service contract selected by the user, a bid or offer price for the selected service contract as well as information sufficient to uniquely identify the user. Those having ordinary skill in the art will recognize that storage for other information necessary for the proper operation of the exchange may also be included in the selection information storage structure 414.

As further shown in FIG. 4, quote data 418, preferably resident in the database 304, is available to the exchange process 308. The quote data 418 comprises all pertinent information regarding quotes provided by each market participant. As described above, service contracts in accordance with the present invention specify standardized terms for duration, quality, delivery and maturity dates and delivery location. While this information may be stored for each quote submitted, it is preferable to instead store an identifier corresponding to the type of contract for each quote and, if desired, to separately store contract specifications that detail the particular terms of each type of contract. Because the duration, quality, delivery, maturity and location terms are standardized, knowledge of the contract type identifier inherently specifies each of the contract terms. In addition to the contract type identifier, each quote stored in the quote data 418 comprises the corresponding bid or offer price entered by respective users and account identifiers likewise corresponding to the respective users. The account identifiers uniquely identify individual users (i.e., natural persons or business entities, in most instances) of the exchange system. Each account identifier comprises information needed to identify and contact users, as well as financial information needed to charge customers that engage in transactions. Temporal information, such as when a particular quote was entered, may also be included. Further still, a status indication may be associated with each quote to indicate whether each particular quote is active, i.e., available for acceptance on the market, or on hold, i.e., not available for acceptance.

The address data 420 comprises all data relevant to any addresses used in the system. In particular, the address data 420 comprises contact information, such as telephone numbers, residence or business addresses and any financial information (e.g., credit account numbers, etc.) needed to settle accounts. Although shown apart from the other types of data, the address data 420 may be incorporated therein, e.g., within the quote data 418. The trade data 422 includes all information relative to quotes that have been accepted in order to track and memorialize specific trades that have occurred through the commodity exchange system. A trade is a sale of a commodity by a seller to a buyer effectuated through the commodity exchange system described herein. To this end, the trade data 422 comprises information sufficient to identify each particular trade, a per contract price for the trade and a number of contracts (quantity) traded. Preferably, buyer and seller account identifiers, as well as trade date information (i.e., the date and time when agreement was reached between the parties to enter into the trade) are also included. Those of skill in the art will recognize that other types of information may also be included in the trade data 422. Finally, the markets data 424 is that data used by the exchange logic 406 to keep track of and present various markets to users of the exchange system. The markets data 424 is further described with reference to FIG. 5 below.

In one embodiment of the present invention, at least portions of the data 414-424 collectively form a data structure suitable for implementing an on-line exchange system. In accordance with the methods described below, such a data structure can be provided in whole or in part to a user's computer (e.g., by downloading a web page comprising the data structure) and used to gather selection information. When all of a user's selection information has been stored in the selection information storage structure 414, the selection information is conveyed back to the exchange controller. This is illustrated in FIG. 4 where the processor 404 transmits the data structure and receives the selection information. As required, elements may be added to or removed from the data structure, thereby increasing its utility for a particular application. Further still, in another embodiment of the present invention, the data structure may include the transmit program 416 in lieu of the selection information storage structure 414. The transmit program 416 is an optional program, such as a “JAVA” applet, included in the data structure that allows selection information to be transmitted to the exchange controller as it is received from the user, rather than waiting for all selection information to be received first. Those having ordinary skill in the art will recognize that other implementations are possible and are a matter of design choice.

The display illustrated in FIG. 5 is an example of a display that would be provided on the computers of users of a commodity exchange system directed to the trade of service contracts in accordance with the present invention. In particular, the display shown in FIG. 5 would be suitable for use with forward or spot markets for service contracts. It should be noted that techniques for obtaining the data included in the display shown in FIG. 5 from databases and data structures, such as those described above relative to FIG. 4, are well known in the art. FIG. 5 illustrates a complete market display 500 in which both the bid and offer sides of markets are displayed. The display 500 is provided to a user deciding whether to take a position in a given market or who has already taken a position and wishes to see a more complete market representation. The market information provided in the complete market display 500 comprises listings for different contract types, as well as the highest bid and lowest offers for each of these markets. For the sake of simplicity, the available service contract types are shown as A through F; in practice, a more descriptive name could be used. The complete market display also includes, for each market displayed, a number of buyers currently having outstanding bids and a number of sellers currently having outstanding offers. In this manner, the complete market display provides a user with a greater sense of the depth of each market.

Having viewed the market information, users may choose to enter new bids or offers, or change existing bids/offers, in selected markets using the bid and offer fields 510, 511 provided. Where a user has not previously entered a bid or offer, they may enter their bid or offer in the appropriate field 510, 511 and select a post bid or offer button 513, 515. Alternatively, where the user has previously entered a bid or offer, that bid or offer will already be displayed in the appropriated bid or offer field 510, 511. However, the user can change any such bid or offer and select the change bid or offer button 512, 516. Cancel buttons (not shown) may be provided such that, if a user decides that he or she wants to cancel all of his or her bid and/or offers, he or she may select either or both of a “cancel all bids” button and a “cancel all offers” button. In yet another alternative, after viewing the market information, the user may select buy or sell buttons 514, 517 for a particular market and immediately enter into a transaction. It should be noted that the markets displayed in FIG. 5 assume trades of single contracts. However, multiple contracts could be traded through the addition of a quantity field.

The present invention provides a technique for implementing trades and establishing markets for service-based commodities, particularly when applied to an on-line exchange system. Standardizing contract duration, quality, delivery date, maturity date and delivery location creates fungible service commodities thereby providing market liquidity. A variety of beneficial results are thereby obtained. For example, forward and spot markets cooperate in a manner not previously possible because the services are deliverable over a period of time. As a result, spot market activity is concentrated on a small number of contracts leading to greater liquidity. Additionally, buyers and sellers are provided a greater degree of flexibility than previously available. However, what has been described is merely illustrative of the application of the principles of the present invention. Those skilled in the art can implement other arrangements and methods without departing from the spirit and scope of the present invention. For example, markets for options and swaptions on forward contracts could be developed.

1. In a commodity exchange system, a method for trading service-based commodities contracts for at least one service, the method comprising:
standardizing, for each of the at least one service, a contract type comprising a service duration, a service quality, a service delivery date, a service maturity date and a service delivery location to provide at least one service contract type; and
receiving quotes for each of the at least one service contract type.

2. The method of claim 1, further comprising:
providing market information, based on the quotes, corresponding to each of the at least one service contract type.

3. The method of claim 2, wherein the step of providing the market information further comprises providing at least one of a highest bid indication and a lowest offer indication for each of the at least one service contract type.

4. The method of claim 3, wherein the step of providing the market information further comprises providing, for each of the at least one service contract type, at least one of an indication of a number of buyers and an indication of a number of sellers.

5. The method of claim 1, wherein the commodity exchange system comprises a plurality of computers in communication with each other via a communication network, and wherein the step of providing the market information further comprises providing the market information to any of the plurality of computers via the communication network.

6. The method of claim 5, wherein the step of receiving further comprises receiving the quotes from any of the plurality of computers via the communication network.

7. The method of claim 1, wherein the service delivery dates and the service maturity dates fall on any of a monthly boundary and a quarterly boundary.

8. An apparatus for use in a commodity exchange system, the apparatus comprising:
means for providing market information for at least one service-based commodity, wherein each of the at least one service-based commodity is standardized to provide at least one service contract type, each of the at least one service contract type comprising a service duration, a service quality, a service delivery date, a service maturity date and a service delivery location; and
means for receiving quotes responsive to the market information.

9. The apparatus of claim 8, wherein the commodity exchange system comprises a plurality of computers in communication with each other via a communication network, and wherein the means for providing the market information further comprises means for providing the market information to any of the plurality of computers via the communication network.

10. The apparatus of claim 9, wherein the means for receiving further comprises means for receiving the quotes from any of the plurality of computers via the communication network.

11. The apparatus of claim 8, wherein the means for providing the market information further comprises means for providing at least one of a highest bid indication and a lowest offer indication for each of the at least one service contract type.

12. The apparatus of claim 11, wherein the means for providing the market information further comprises means for providing, for each of the at least one service contract type, at least one of an indication of a number of buyers and an indication of a number of sellers.

13. A computer-readable medium having stored thereon a data structure specifying a service contract type corresponding to a service comprising:
a service duration field indicating duration of the service contract type;
a service quality field indicating a quality level for the service contract type;
a service delivery date field indicating a delivery date for the service contract type;
a service maturity date field indicating a maturity date for the service contract type; and
a service delivery location field indicating a service delivery location for the service contract type.

14. A commodity exchange system comprising the computer-readable medium of claim 13.
